(19) United States
(12) Patent Application Publication
(10) Pub. No.: US 2024/0416764 A1
(43) Pub. Date: Dec. 19, 2024

(54) BATTERY SYSTEM FOR HEAVY DUTY VEHICLES

(71) Applicant: Hexagon Purus North America Holdings Inc., Costa Mesa, CA (US)

(72) Inventors: Todd F. Sloan, Kelowna (CA); Chris Forsberg, Kelowna (CA); Landon Tyerman, Kelowna (CA); Eric M. Coupal-Sikes, Kelowna (CA); Brad Jonathan van Hanegem, Kelowna (CA)

(21) Appl. No.: 18/768,675

(22) Filed: Jul. 10, 2024

Related U.S. Application Data
(63) Continuation of application No. 18/463,147, filed on Sep. 7, 2023, now abandoned.
Application No. 18/463,147 is a continuation of application No. 17/338,315, filed on Jun. 3, 2021, now Pat. No. 11,780,337.
Application No. 17/338,315 is a continuation of application No. 16/863,131, filed on Apr. 30, 2020, now Pat. No. 11,043,714.
Application No. 16/863,131 is a continuation of application No. PCT/US2019/047773, filed on Aug. 22, 2019.
(60) Provisional application No. 62/722,758, filed on Aug. 24, 2018.

(51) Int. Cl. B60L 50/64; B60K 1/04; H01M 50/204; H01M 50/244; H01M 50/249; H01M 50/262

(52) U.S. Cl. CPC B60L 50/64; B60K 1/04; H01M 50/204; H01M 50/244; H01M 50/249; H01M 50/262; H01M 2220/20

(57) ABSTRACT

The present disclosure relates to a battery system for a hybrid or an electric vehicle. Another aspect of the present disclosure provides a battery assembly designed for easy and quick exchange of battery assemblies enabling a vehicle to resume driving much more quickly than traditional charging permits.

### INCORPORATION BY REFERENCE TO ANY PRIORITY APPLICATIONS

Any and all applications for which a foreign or domestic priority claims is identified in the Application Data Sheet as filed with the present application are hereby incorporated by reference under 37 C.F.R. § 1.57

### BACKGROUND

### Field

The present disclosure relates to battery systems for heavy-duty vehicles and a method for equipping heavy-duty vehicles with such systems.

### Related Art

The use of alternative fuels for vehicles is becoming more prevalent. Natural gas powered automobiles produce less harmful emissions than do automobiles powered by traditional fossil fuels. A growing trend is the use of electrical motors for propulsion.

Electric drive systems have become ubiquitous for small passenger vehicles. However, long wait time to charge batteries is an obstacle to wider adoption of electric drive systems.

### SUMMARY

An aspect of the present invention provides a battery system for a hybrid or an electric vehicle. Another aspect of the present invention provides a battery assembly designed for easy and quick exchange of battery assemblies enabling a vehicle to resume driving much more quickly than traditional charging permits.

In one embodiment a battery assembly is provided for an electric vehicle. The battery assembly has a housing, one or more battery units and a mounting system. The housing has a first lateral portion, a second lateral portion, and a central portion. The housing forms an upwardly oriented recess between the first and second lateral portions. The mounting system can be disposed at least partially between the first lateral portion and the second lateral portion. A frame member of a vehicle can be disposed between first and second lateral portions. When so disposed, the frame member can be coupled to the mounting system between first and second lateral portions above the central portion.

In one embodiment, the one or more battery units is or are disposed within the housing at least in the central portion.

In some variations, at least a portion of the one or more battery units is disposed in the first lateral portion. In some variations, at least a portion of the one or more battery units is disposed in the second lateral portion. In some variations, at least a portion of the one or more battery units is disposed in the first lateral portion and in the second lateral portion.

In another embodiment the housing comprises a W-shaped housing.

The housing can be configured to be exposed to the road beneath the vehicle when the battery assembly is coupled to a frame member of a vehicle.

The mounting system can comprise a first component coupled with the housing and a second component configured to be coupled with the frame member. The first component can be configured to be releasably coupled to the second component. In this context, the releasable coupling can be one that facilitates quick exchange of the battery assembly for another, fully charged, battery assembly.

Where provided the second component of the mounting system can be configured to be coupled with a lateral portion of, e.g., an outwardly facing side of, the frame member.

When provided, the second component of the mounting system can include one or more brackets disposed on one or both of a first inside surface of the first lateral portion and on a second inside surface of the second lateral portion.

Where provided, the brackets of the mounting system can include U-shaped members configured to be disposed around the second component of the mounting system.

The housing is configured such that a lengthwise frame member of the vehicle can be disposed between the first lateral portion and the second lateral portion.

In some embodiments, the housing is configured to be coupled to the mounting system from beneath the vehicle. The housing can be moved transversely to the long axis of the vehicle, e.g., between forward and rearward wheels of the vehicle. The housing can be moved longitudinally along the long axis of the vehicle, e.g., under an axle between driver side and passenger side wheels coupled with the axle.

### BRIEF DESCRIPTION OF THE DRAWINGS

The systems, methods and devices may be better understood from the following detailed description when read in conjunction with the accompanying schematic drawings, which are for illustrative purposes only. The drawings include the following figures:

FIG. 1A is a perspective view of a truck having a fossil fuel system that can be configured with an electric power propulsion system according to an embodiment of the invention;

FIG. 1B is a side view of the a truck according to an embodiment of the invention;

FIG. 1C is a bottom view of a truck according to an embodiment of the invention;

FIG. 1D is a rear view of a truck according to an embodiment of the invention;

FIG. 2 is a schematic view of a battery assembly of an electric drive system according to an embodiment of the invention;

FIG. 3 is a perspective view of a battery assembly according to an embodiment of the invention coupled with frame rails of a vehicle;

FIG. 4 is a top view of the battery assembly of FIG. 3 coupled with frame rails of a vehicle;

FIG. 5 is a cross-sectional view of one embodiment of the battery assembly of FIGS. 3-4 taken at section plane 5-5 in FIG. 4;

FIGS. 6A to 7C illustrate apparatuses and processes for mounting a battery assembly according to an embodiment of the invention.

### DETAILED DESCRIPTION

This application is directed to novel electric vehicle components and assemblies. The components described and claimed herein can be used in vehicles that are powered solely by electric motor(s) and in vehicles that are powered by a combination of power sources including electric motors and fossil fuels, e.g., natural gas fuel systems.

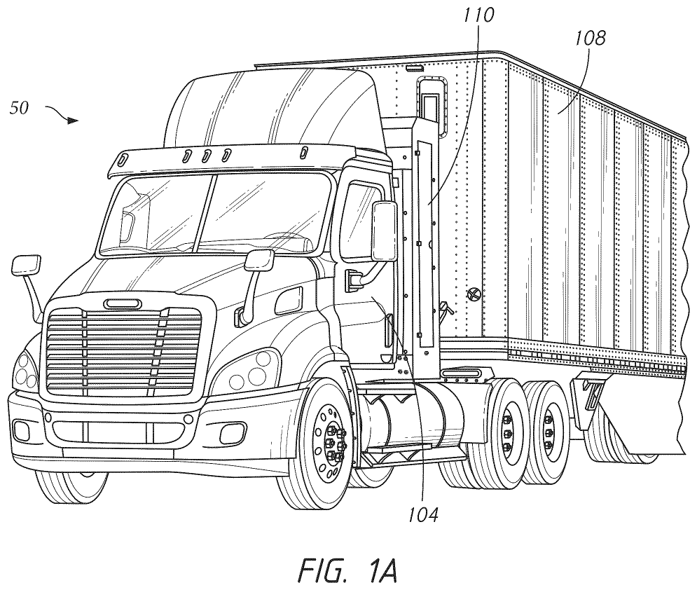

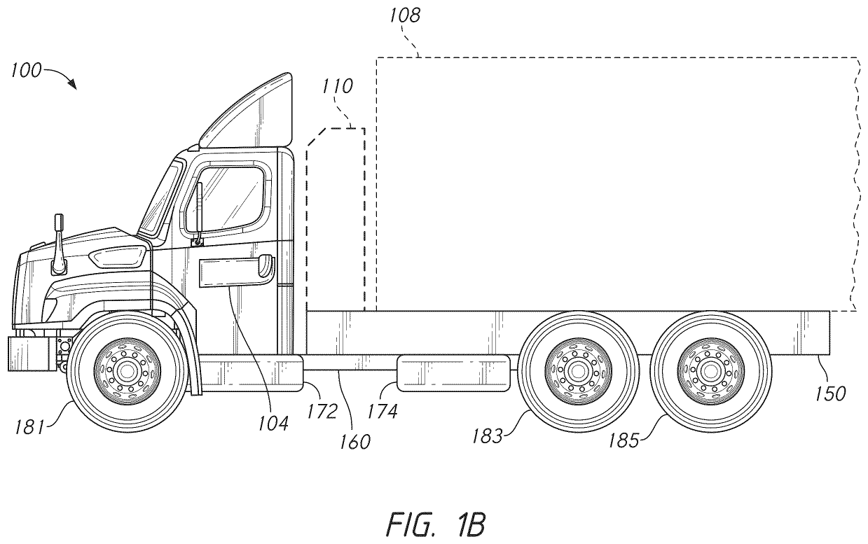

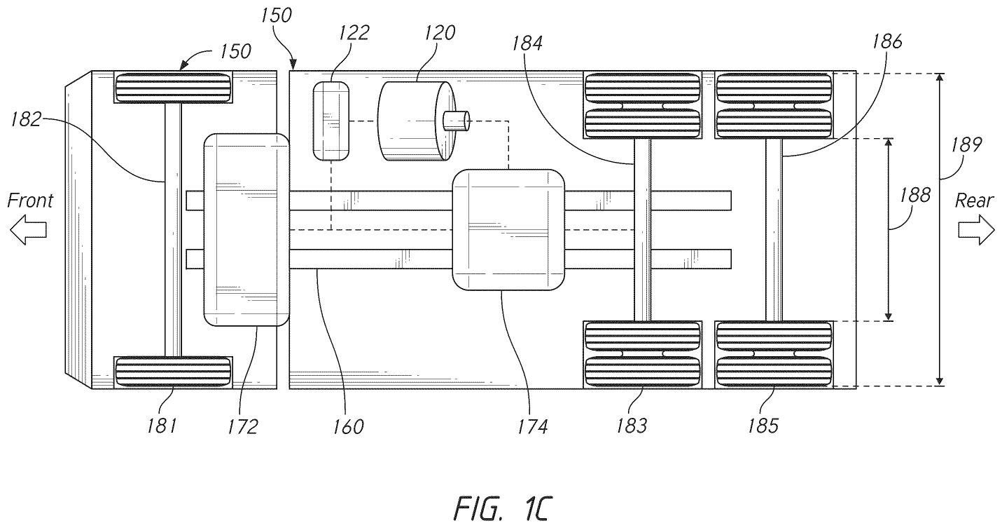

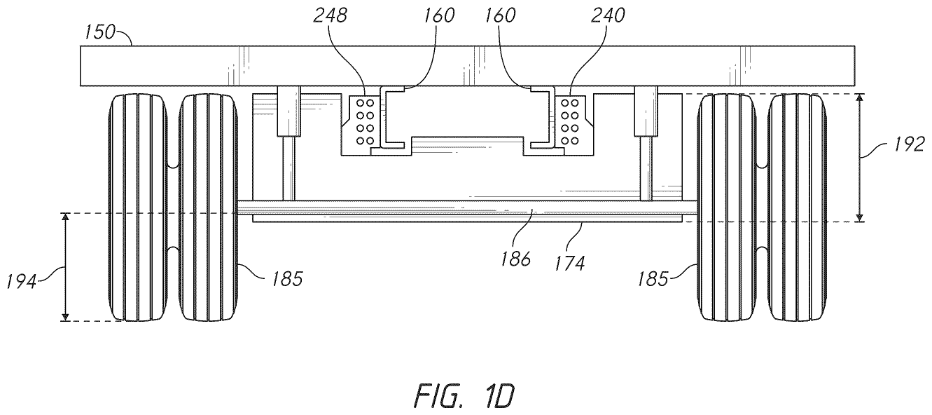

FIG. 1A illustrates a vehicle 50 with a fossil fuel system 110 disposed within an enclosure behind a cab 104. The fuel system 110 can power a combustion engine. The vehicle 100 can be powered by an electric motor (not shown) as disclosed herein. In one embodiment, the truck has multiple distinct energy sources that are capable of operating independently. In certain embodiments, the truck has no combustion engine and uses an electric motor for its propulsion power.

FIG. 1B illustrates a side view of a vehicle 100 according to an embodiment of the invention. The vehicle 100 has a cab 104 and a vehicle frame for loading cargo 108. The vehicle 100 has an electric drive system and at least one battery to power the electric drive system. The fossil fuel system 110 is shown in dash line, indicating that in this embodiment such a system is optional and may not be present.

In FIG. 1B, a first battery assembly 172 is located under the cab 104 and a second battery assembly 174 is located under the cargo frame 150. In certain embodiments, the truck has no battery to power its electric drive system under the cab 104, and instead has one or more battery assemblies under the cargo area of the vehicle. In certain embodiments, the truck has no battery to power its electric drive system under the cargo frame 150 and instead has one or more battery assemblies forward of the cargo area, e.g., under the cab 104.

In FIG. 1B, the two batteries 172, 174 are coupled to a beam 160 that is fixed to the cargo frame 150 and/or a frame of the cab 104. The beam 160 is a structural member that bears the load of the cargo frame 150 and also supports other components directly or indirectly, such as the wheels and axles. The beam 160 is sometimes referred to herein as a rail or frame rail. In certain embodiments, a battery to power the vehicle's electric drive system is fixed to a frame of the cab 104.

Referring to FIG. 1B, the second battery assembly 174 is sized such that the second battery assembly 174 does not overlap the wheels 181, 183, 185 of the truck. FIG. 1C shows that if the battery assembly 174 is forward of the rear wheels 183, 185, the width dimension of a housing of the battery assembly 174 can be greater than the distance 188 between the inside of the inner wheels. Generally, the battery assembly 174 will not be wider than the distance 189 between the outer sides of the outermost wheels.

FIG. 1C illustrates a bottom view of the vehicle 100 according to an embodiment of the invention. The truck has at least one beam (or frame rail) 160 installed under the cab 104 and the cargo frame 150. The beam 160 extends generally along a longitudinal direction of the vehicle 100 for holding the cargo frame 150 and other systems such as the wheels and axles, suspension, exhaust, as well as one or both of the battery assemblies 172, 174. Referring to FIG. 1C, the beam 160 extends to overlap a first rear-wheel axle 184 adjacent to or immediately neighboring the front-wheel axle 182. The beam 160 does not extend beyond the front-wheel axle 182 or beyond the first rear-wheel axle 186 in some embodiments. In certain embodiments, the beam 160 extends to overlap all of the axles 182, 184, 186 or does not overlap any of the axles 182, 184, 186 when viewed from the bottom. FIG. 1C shows that the battery assemblies 172, 174 are located in a space between the front-wheel axle 182 and the rear-wheel axle 184 adjacent to or immediately neighboring the front-wheel axle 182 in one embodiment.

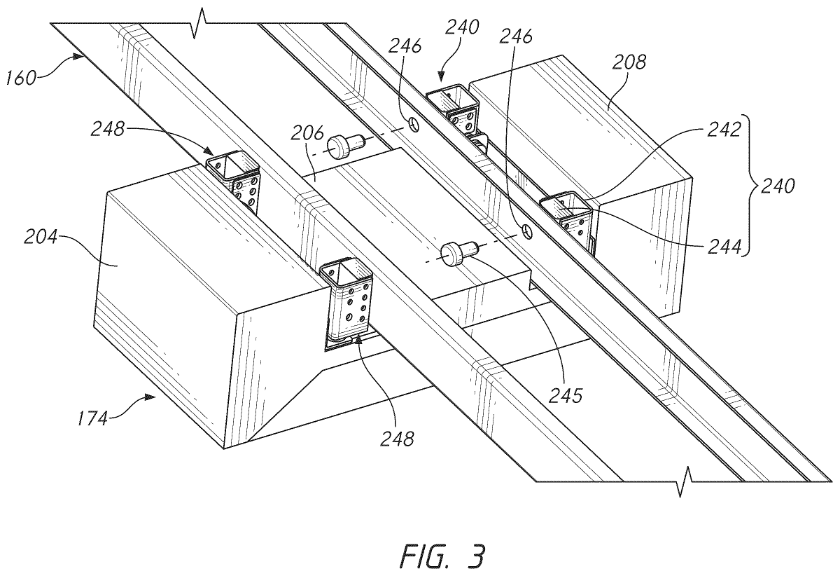

FIG. 1D illustrates a rear view of the vehicle 100 according to an embodiment of the invention. The beam 160 is installed under the cargo frame 150 between rear wheels 185. The battery assembly 174 is coupled to the beam 160 using mounting systems 240, 248. In certain embodiments, the clearance 194 below the rear axles 184, 186 is greater than the height 192 of the battery assembly 174 such that the battery assembly 174 can move under the rear axles 184, 186 and between the rear wheels 185 for exchanging battery assemblies. Manners of securing the first battery 172 or the second battery 174 to the 160 are discussed below in connection with FIGS. 3-5, FIGS. 6A-6C and FIGS. 7A-7C.

FIG. 1C is a schematic view of an electric drive system according to an embodiment of the invention. The vehicle 100 uses at least one motor 120 for propulsion. At least one battery assembly 172, 174 of the vehicle 100 provides power in the form of electric current to drive the motor 120. The vehicle 100 comprises an electric current conveyance system 122 for connecting the battery assembly 172, 174 and the motor 120. The vehicle 100 has a transmission system (not shown) to deliver torque generated by the motor 120 to one or more wheel driving axles, e.g., to the axle 184.

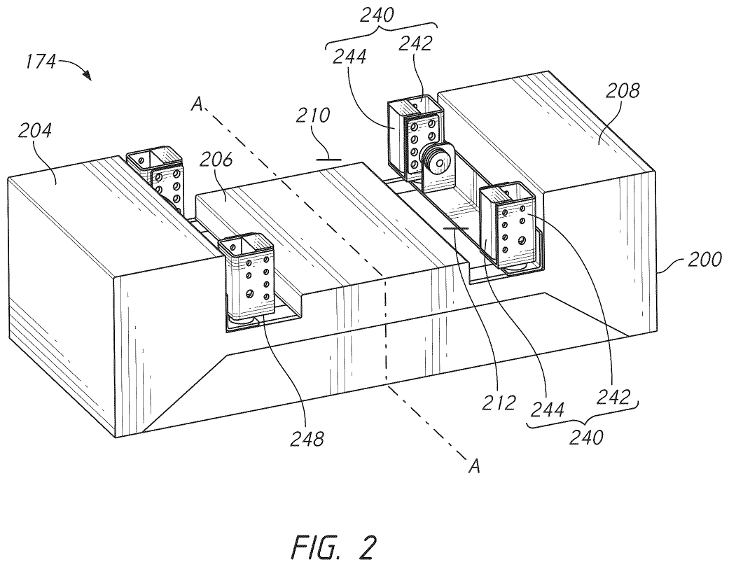

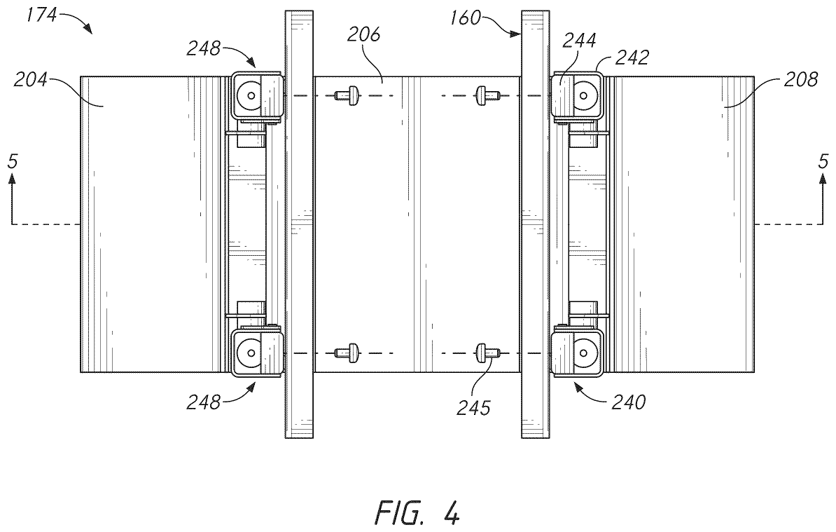

FIG. 2 is a perspective view of the battery assembly 174 according to an embodiment of the invention. FIG. 3 illustrates the battery assembly 174 coupled with the beam 160. FIG. 4 is a top view of the battery assembly 174 coupled with the beam 160.

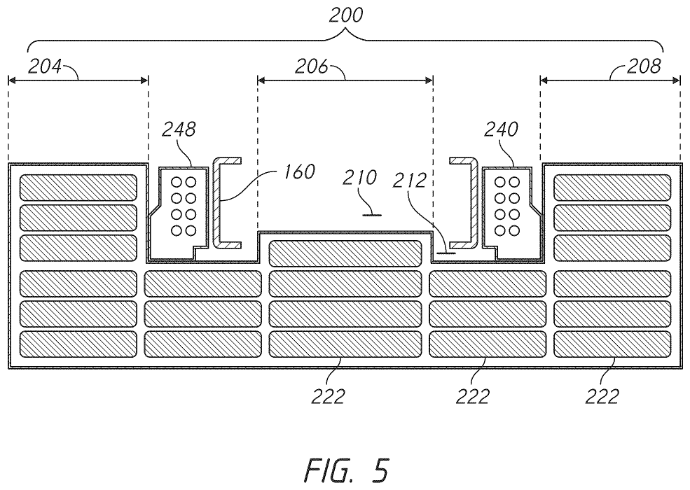

Referring to FIG. 2, the battery assembly 174 includes a housing 200 and at least one mounting system 240, 248 for coupling the battery assembly 174 to the beam 160. The housing 200 comprises a first lateral portion 204, a second lateral portion 208, and a central portion 206 interposed between the lateral portions 204, 208 in one embodiment. The central portion 206 does not extend as far in the vertical direction as the lateral portions 204, 208. A space 210 is provided between the lateral portions 204, 208 to receive the beam 160 as illustrated in FIGS. 4 and 5. The space 210 can be disposed between an inward facing surface of the first lateral portion 204 and an inward facing surface of the second lateral portion 204. The inward facing surface can be surfaces that face toward a central vertical longitudinal plane of the vehicle 100 when the battery assembly 174 is mounted thereto. In other words, the inward surfaces can be closer to the central vertical longitudinal plane than are outward surfaces of the first and second lateral portions 204, 208 which face away from that central longitudinal plane.

The housing 200 of the battery assembly 174 is generally symmetrical about a central plane A-A. The mounting system 240 and the mounting system 248 are also symmetrical about the central plane A-A. In certain embodiments, the battery assembly 174 is asymmetrical about the plane A-A, and the mounting system 248 connected to the first lateral portion 204 and the mounting system 240 connected to the second lateral portion 208 have different configurations.

At least one mounting system 240 is provided in a recess 212 between the central portion 206 and the first lateral portion 204. The recess 212 can include a bight formed by the housing 200. The bight can be formed in a concave periphery on the top side of the housing 200. The bight can include a more complex shape such as two U-shaped or concave portions on opposite sides of a central vertical plane of the housing 200. The mounting system 240 includes a first member 242 fixed to a wall of the housing 200 (e.g., to a wall of the second lateral portion 208) that is facing the beam 160 and a second member or component 244 for connecting the first member 242 to the beam 160. In some embodiments, when the battery 174 is lifted to a position where the first member 242 of the mounting system 240 is at a level of the beam, the second member 244 is fixed to the beam by fastening a bolt (that is accessible from the space 206). In certain embodiments, the second member 244 is fixed to the beam using at least one bolt 245, the beam 160 has at least one through hole 246 for receiving the bolt 245, and the second member 244 has at least one screw hole for receiving the bolt 245. In certain embodiments, a procedure to secure the battery assembly 174 to the beam comprises: (1) when the vehicle 100 is parked, moving the battery assembly 174 on or over the ground to place it under the beam 160; (2) lifting the battery assembly 174 to a set position of FIG. 3 where the through hole 246 is aligned with a screw hole of the bracket 244; and (3) fastening the bolt 245 to bracket 244 passing the through hole 246. In various techniques, a motorized screwdriver, impact wrench or other hand tool can access the bolt 245 in the space 210 over the central portion 206 of the battery assembly 174. In another method, the second member 244 is secured to the beam 160 and the bolt 245 may be advanced through any of the holes in the side of the first member 242. More specifically, the bolt 245 can be advanced through any of the holes in a direction parallel to the central plane A-A and into the second member 244. An impact wrench or other tool can be used to secure the bolt 245 in this direction and in this manner.

FIG. 5 is a cross sectional view of the battery assembly 174 coupled with the frame rails 160 of a vehicle as shown in FIG. 4. The housing 200 of the battery assembly 174 contains or encloses a plurality of battery units or cells 222. The housing 200 is fixed to the beam (e.g., frame rail) 160 using the mounting system 240, 248 such that some of the battery units 222 are disposed laterally of the frame rails 160 and some are disposed between the frame rails 160. More particularly, the mounting system 240 enables the frame rails 160 to support battery cells over a wide area beneath the vehicle 100, with some battery cells at the central vertical longitudinal plane of the vehicle 100, and some disposed laterally between the central vertical longitudinal plane of the vehicle 100 and the frame rails 160 and with some of the battery cells laterally between the frame rails 160 and the lateral outer extent of the vehicle 100, e.g., such that the frame rails are between at least some of the battery cells 222 and the central vertical longitudinal plane of the vehicle 100. Referring to the at least one battery cell 222 are contained in portions of the housing 200 corresponding to the mounting system 240, e.g., in the central portion 212 of the housing, at a level of, lateral of, and/or below the mounting system 240 to increase the number of contained battery cells while allowing a vacant space 210 between the lateral portions 204, 208.

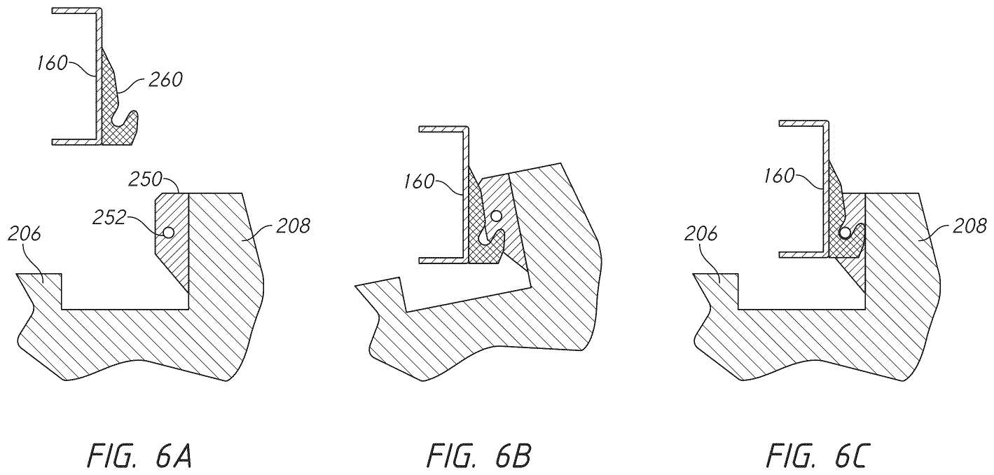

FIGS. 6A to 6C illustrate processes for mounting a battery assembly according to an embodiment of the invention. A first bracket 260 fixed to the beam 160 is engaged with a second bracket 250 for coupling the lateral portion 208 of the housing to the beam. The lateral portion 208 and the second bracket 250 can be moved from one side of the vehicle 100 under the frame rails 160 across the central vertical longitudinal plane of the vehicle 100 then lifted to be disposed over at least a portion of the first bracket 260. When the battery cell 174 is lifted from a set position of FIG. 6A to a lifted position of FIG. 6B, a coupling pin 252 of the second bracket 250 is elevated above a recess 262 of the first bracket 260. When the battery assembly is in a mounted position of FIG. 6C, the coupling pin 252 is received in the recess 262 of the first bracket 260 such that one side of the battery assembly 174 is coupled to one of the beams 160 of the vehicle. In certain embodiments, subsequent to coupling the lateral portion 208 to the beam 160 in the mounted position of FIG. 6C, another mounting system 248 connected to the lateral portion 204 at the other side of the battery assembly 174 is aligned with the beam 160 and then secured to the beam 160 using a bolt (or other fastening system) to prevent the battery assembly 174 from moving relative to the beam 160 and to prevent the coupling pin 252 from coming out of the recess 262. More details about coupling of the brackets 250, 260 can be found in PCT Application No. PCT/US2016/039363, which is hereby incorporated in its entirety by reference as if fully set forth herein.

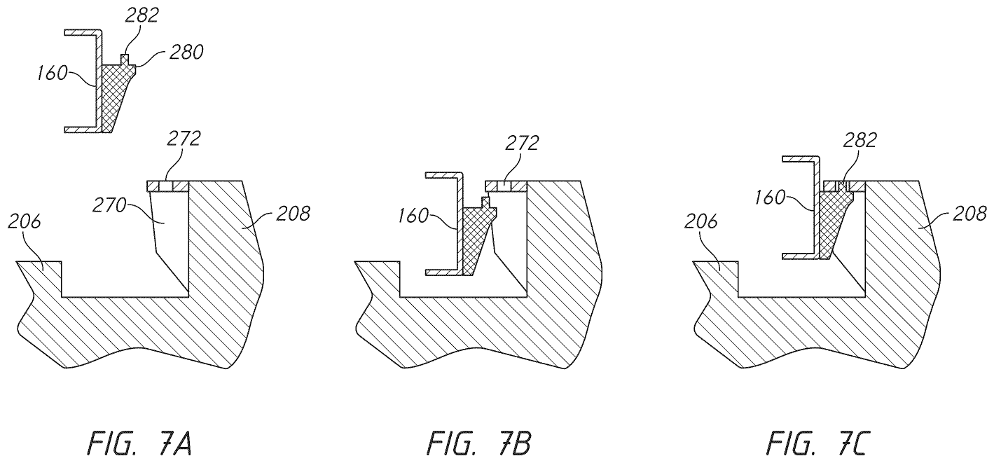

FIGS. 7A to 7C illustrate a process for mounting a battery assembly according to an embodiment of the invention. A third bracket 280 fixed to the beam 160 is engaged with a fourth bracket 270 for coupling the lateral portion 208 of the housing to the beam 160. When the battery cell 174 is lifted from a set position of FIG. 7A to a lifted position of FIG. 7B, a coupling protrusion 282 of the third bracket 280 is elevated over a hole 272 of the forth bracket 270. When the battery assembly is in a mounted position of FIG. 7C, the coupling protrusion 282 is inserted to the hole 272 of the fourth bracket 270 such that the battery cell 174 is coupled to the beam 160. In some embodiments, subsequent to coupling the lateral portion 208 to the beam 160 in the mounted position of FIG. 7C, another mounting system 248 connected to the lateral portion 204 at the other side of the battery assembly 174 is aligned with the beam 160 and then secured to the beam 160 using a bolt (or other fastening system) to prevent the battery assembly 174 from moving relative to the beam 160 and to prevent the coupling pin 252 from coming out of the recess 262. More details about coupling of the brackets 270, 280 can be found in U.S. application Ser. No. 14/057,410, which is hereby incorporated in its entirety by reference as if fully set forth herein.

### Further Details of the Fuel System

FIG. 1A tshows the fuel system 110 mounted to the vehicle 50 in a behind-the-cab or back-of-cab configuration. More details of the fuel system 110 can be found in U.S. application Ser. No. 15/014,933 which is hereby incorporated in its entirety by reference as if fully set forth herein.

While the present description sets forth specific details of various embodiments, it will be appreciated that the description is illustrative only and should not be construed in any way as limiting. Furthermore, various applications of such embodiments and modifications thereto, which may occur to those who are skilled in the art, are also encompassed by the general concepts described herein. Each and every feature described herein, and each and every combination of two or more of such features, is included within the scope of the present invention provided that the features included in such a combination are not mutually inconsistent.

The above presents a description of systems and methods contemplated for carrying out the concepts disclosed herein, and of the manner and process of making and using it, in such full, clear, concise, and exact terms as to enable any person skilled in the art to which it pertains to make and use this invention. The systems and methods disclosed herein, however, are susceptible to modifications and alternate constructions from that discussed above which are within the scope of the present disclosure. Consequently, it is not the intention to limit this disclosure to the particular embodiments disclosed. On the contrary, the intention is to cover modifications and alternate constructions coming within the spirit and scope of the disclosure as generally expressed by the following claims, which particularly point out and distinctly claim the subject matter of embodiments disclosed herein.

Although embodiments have been described and pictured in an exemplary form with a certain degree of particularity, it should be understood that the present disclosure has been made by way of example, and that numerous changes in the details of construction and combination and arrangement of parts and steps may be made without departing from the spirit and scope of the disclosure as set forth in the claims hereinafter.

1. (canceled)

2. A battery assembly for an electric vehicle, comprising:
a housing having a first outwardly facing side, a second outwardly facing side, and a central portion, the housing forming a first upwardly facing surface between the first outwardly facing side and the second outwardly facing side, the first outwardly facing side and the second outwardly facing side extending in a lengthwise direction relative the electric vehicle when the battery assembly is coupled to the electric vehicle;
one or more battery units disposed within the housing; and
a mounting system configured to couple the housing to frame rails of the electric vehicle, the mounting system having a first portion configured to contact and be coupled to the frame rails and a second portion having a second upwardly facing surface and being configured to support at least a portion of a load of the housing resting on top of the second portion, the second upwardly facing surface positioned below a surface of the housing.

3. The battery assembly of claim 2, wherein the housing comprises an upward oriented recess formed in part by the first upwardly facing surface.

4. The battery assembly of claim 2, wherein the first outwardly facing side, the second outwardly facing side, and the first upwardly facing surface form an upwardly oriented space, the upwardly oriented space accessible from a forward facing side and a rearward facing side.

5. The battery assembly of claim 2, wherein the housing comprises a W-shaped housing.

6. The battery assembly of claim 2, wherein the housing is configured to be exposed to a road beneath the electric vehicle when the battery assembly is coupled to a frame member of the electric vehicle.

7. The battery assembly of claim 2, wherein the mounting system further comprises a third portion coupled with the housing and configured to be releasably coupled to the second portion.

8. The battery assembly of claim 2, wherein the first portion of the mounting system is configured to be coupled to an outboard side of a frame rail of the frame rails.

9. The battery assembly of claim 2, wherein at least a portion of one of the one or more battery units is disposed in a first lateral portion disposed between the central portion and the first outwardly facing side and/or in a second lateral portion disposed between the central portion and the second outwardly facing side.

10. The battery assembly of claim 9, wherein at least one of the first lateral portion and the second lateral portion extend upwardly along a vertical portion of the mounting system.

11. The battery assembly of claim 2, wherein the mounting system is configured to couple the housing to the electric vehicle from beneath the electric vehicle.

12. The battery assembly of claim 2, wherein the mounting system comprises a pin and groove connection facilitating at least partial support of the housing on the frame rails of the electric vehicle without additional fasteners.

13. The battery assembly of claim 2, wherein the mounting system is configured to support the battery assembly from only outward sides of a frame assembly.

14. A battery assembly for an electric vehicle, comprising:
a housing having a first outwardly facing side, a second outwardly facing side, and a central portion, the housing forming a first upwardly facing surface between the first outwardly facing side and the second outwardly facing side, the first outwardly facing side and the second outwardly facing side extending in a lengthwise direction relative the electric vehicle when the housing is coupled to the electric vehicle;
one or more battery units disposed within the housing; and
a mounting system configured to couple the housing to a plurality of frame rails of the electric vehicle, the mounting system having a first portion configured to be coupled to the plurality of frame rails and a second portion having a second upwardly facing surface and being configured to be disposed under a downward facing surface of the housing to support at least a portion of a load of the housing.

15. The battery assembly of claim 14, wherein the housing comprises an upward oriented recess formed in part by the first upwardly facing surface.

16. The battery assembly of claim 14, wherein the first outwardly facing side, the second outwardly facing side, and the first upwardly facing surface form an upwardly oriented space, the upwardly oriented space accessible from a forward facing side and a rearward facing side.

17. The battery assembly of claim 14, wherein the housing comprises a W-shaped housing.

18. The battery assembly of claim 14, wherein the housing is configured to be exposed to a road beneath the electric vehicle when the housing is coupled to a frame member of the electric vehicle.

19. The battery assembly of claim 14, wherein the mounting system further comprises a third portion coupled with the housing and configured to be releasably coupled to the second portion.

20. The battery assembly of claim 14, wherein the first portion of the mounting system is configured to be coupled to an outboard side of a frame rail of the plurality of frame rails.

21. The battery assembly of claim 14, wherein at least a portion of one of the one or more battery units is disposed in a first lateral portion disposed between the central portion and the first outwardly facing side and/or in a second lateral portion disposed between the central portion and the second outwardly facing side.

22. The battery assembly of claim 21, wherein at least one of the first lateral portion and the second lateral portion extend upwardly along a vertical portion of the mounting system.

23. The battery assembly of claim 14, wherein the mounting system is configured to couple the housing to the electric vehicle from beneath the electric vehicle.

24. The battery assembly of claim 14, wherein the mounting system comprises a pin and groove connection facilitating at least partial support of the housing on the plurality of frame rails of the electric vehicle without additional fasteners.

25. The battery assembly of claim 14, wherein the mounting system is configured to support the housing from only outward sides of a frame assembly.

26. An electric vehicle comprising:
the battery assembly of claim 14; and
the plurality of frame rails.
